(19) United States
(12) Patent Application Publication
(10) Pub. No.: US 2026/0089390 A1
(43) Pub. Date: Mar. 26, 2026

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: ASUKA KANNO, Kanagawa (JP)

(21) Appl. No.: 19/333,673

(22) Filed: Sep. 19, 2025

(30) Foreign Application Priority Data
Sep. 24, 2024 (JP) 2024-165529

(51) Int. Cl. H04N 23/661

(52) U.S. Cl. CPC H04N 23/661

(57) ABSTRACT

An information processing apparatus includes one or more memories storing instructions and one or more processors. The processors function as: an image capturing control unit configured to control capturing of an image of surroundings of the information processing apparatus; a detection unit configured to detect an event of starting the capturing of an image; a display control unit configured to display, on a display screen, a captured image captured based on the control by the image-capturing control unit; a connection unit configured to perform remote operation connection with a communication apparatus; and a control unit configured to perform control to stop the capturing of an image by the image-capturing control unit, or to stop the remote operation connection, in a case where a request for the remote operation connection is received in the connection unit, or where the event is detected by the detection unit during the remote operation connection.

### BACKGROUND

### Field of the Technology

The present disclosure relates to an information processing apparatus, a method for controlling an information processing apparatus, and a storage medium.

### Description of the Related Art

An image forming apparatus such as a multifunction peripheral is a type of an information processing apparatus. A function called a remote operation which displays a screen of an operation panel of an image forming apparatus on a remote client by using VNC (Virtual Network Computing) or the like, and allows an operation from a remote location is known.

In the case of remotely operating an image forming apparatus, it is necessary to consider security. For example, a technology of imposing a display restriction in a remote operation in the case where a specific screen such as a login screen is displayed on an operation panel of an image forming apparatus is known (Japanese Patent Laid-Open No. 2021-160141).

There is a demand for further improvement in security in a remote operation.

### SUMMARY

An information processing apparatus according to one aspect of the present disclosure includes: one or more memories storing instructions; and one or more processors which function as: an image-capturing control unit configured to control capturing of an image of surroundings of the information processing apparatus; a detection unit configured to detect an event of starting the capturing of an image; a display control unit configured to display, on a display screen, a captured image which is an image captured based on the control by the image-capturing control unit; a connection unit configured to perform remote operation connection with a communication apparatus, to display, in the communication apparatus, an image displayed on the display screen, and to enable an operation from the communication apparatus to the information processing apparatus; and a control unit configured to perform control to stop the capturing of an image by the image-capturing control unit, or to stop the remote operation connection, in a case where a request for the remote operation connection is received in the connection unit, or in a case where the event is detected by the detection unit during the remote operation connection.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example of a configuration of a communication system.

FIG. 2 is a block diagram showing an example of a hardware configuration of a communication apparatus.

FIG. 3 is a block diagram showing an example of a software configuration of the communication apparatus.

FIG. 4 is a block diagram showing an example of a hardware configuration of an MFP.

FIG. 5 is a block diagram showing an example of a software configuration of the MFP.

FIGS. 6A and 6B are flowcharts showing an example of processing executed in the MFP.

FIGS. 7A and 7B are examples of camera image-capturing error screens.

FIG. 8 is a diagram showing an example of a software configuration of an MFP.

FIG. 9 is a flowchart showing an example of transmission processing of a screen image during remote operation connection in the MFP.

FIGS. 10A to 10C are diagrams for explaining transmission images.

FIG. 11 is a diagram showing an example of a software configuration of an MFP.

FIG. 12 is a diagram showing an example of a software configuration of a communication apparatus.

FIGS. 13A and 13B are flowcharts showing an example of transmission and reception processing of screen information during remote operation connection.

FIG. 14 is a diagram showing screen information in the case where image capturing is not performed by a camera.

FIGS. 15A and 15B are flowcharts showing an example of processing executed in an MFP.

### DESCRIPTION OF THE EMBODIMENTS

Hereinafter, preferred embodiments of the present disclosure will be described with reference to the attached drawings. Note that the following embodiments are not intended to limit the matters of the present disclosure, and all the combinations of features described in the following embodiments are not necessarily essential for the solution of the present disclosure. Note that the same constituent elements are denoted by the same reference signs.

### First Embodiment

### Overview

There is a case where a camera for reading a predetermined code (hereinafter, referred to as a two-dimensional code) such as a QR code (registered trademark) is mounted in an image forming apparatus, and authentication is performed by using a read image. In such a configuration, a captured image captured by using the camera is displayed on an operation panel in order to check whether the subject is captured within the camera.

Here, if remote operation connection is performed during image capturing using the camera, there is a possibility that a captured image of the surroundings of the image forming apparatus is exposed to a user who is performing the remote operation connection under a situation which is not intended by the user using the image forming apparatus. As a result, a security issue sometimes occurs. In the embodiment described below, control is performed such that remote operation connection and image capturing by a camera are not simultaneously performed. An example in which a captured image is prevented from being exposed to a client who is performing remote operation connection (hereinafter, referred to as a remote client) to thus improve security in this way will be described.

### Configuration

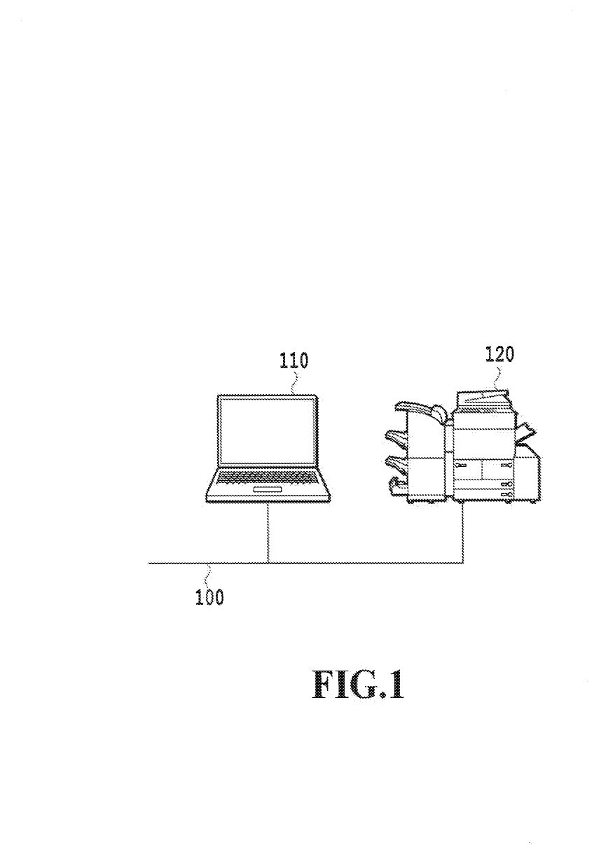

FIG. 1 is a diagram showing an example of a configuration of a communication system in the present embodiment. The communication system includes a communication apparatus 110 and an MFP (Multifunction Peripheral) 120. The communication apparatus 110 and the MFP 120 communicate via a network 100. Note that although in the example of FIG. 1, one communication apparatus 110 and one MFP 120 are connected to the network 100, a plurality of communication apparatuses 110 and a plurality of MFPs 120 may be provided. The communication apparatus 110 is configured such that applications can be installed in the communication apparatus 110.

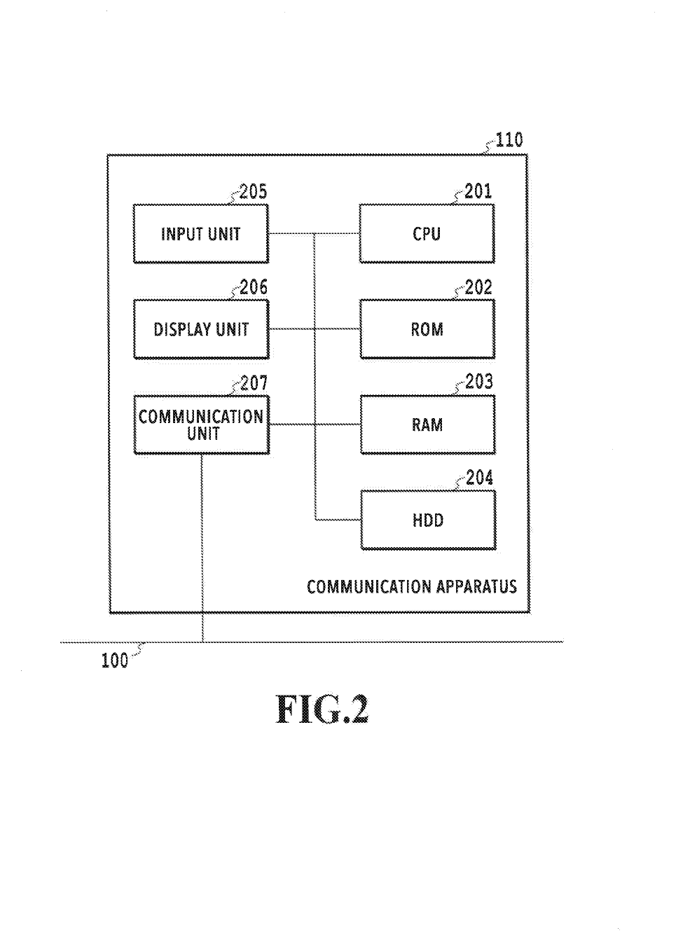

FIG. 2 is a block diagram showing an example of a hardware configuration of the communication apparatus 110. The communication apparatus 110 of the present embodiment is assumed to be an information processing apparatus such as a PC, a smartphone, a tablet, or the like, but may be another apparatus as long as the apparatus is capable of communicating with the network 100. The communication apparatus 110 includes a CPU 201, a ROM 202, a RAM 203, an HDD 204, an input unit 205, a display unit 206, and a communication unit 207.

The CPU 201 reads out a control program stored in the ROM 202, and executes various kings of processing for controlling the operation of the communication apparatus 110. The ROM 202 stores the control program. The RAM 203 is used as temporary storage areas such as a main memory and a work area for the CPU 201. The HDD 204 stores an operating system, a system software, applications, as well as various data such as pictures and electronic documents. As the HDD 204, any storage device can be used as long as the device can store data. For example, as the HDD 204, another storage device such as an SSD (Solid State Drive), an SD memory card, or an eMMC (embedded Multi Media Card) may be used.

The input unit 205 receives input to the communication apparatus 110. Although the present embodiment has a configuration in which the input unit 205 is included in the communication apparatus 110, the input unit 205 may be included in a terminal outside the communication apparatus 110. The display unit 206 displays various screens. In the present embodiment, the input unit 205 and the display unit 206 are described as separate configurations. However, the input unit 205 and the display unit 206 may be configured as an integral unit like a touch panel capable of detecting touch operations of the user. The communication unit 207 executes communications using the network 100. The configuration shown in FIG. 2 is merely an example, and part of the configuration shown in FIG. 2 does not have to be included, and a configuration other than the configuration shown in FIG. 2 may be included.

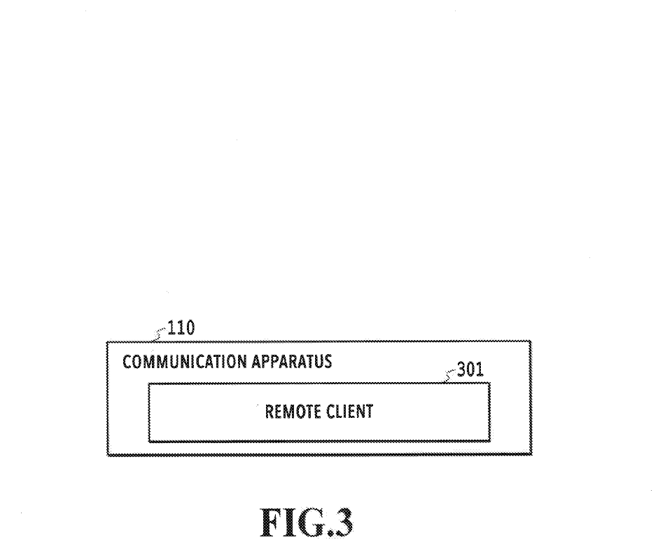

FIG. 3 is a block diagram showing an example of a software configuration of the communication apparatus 110. FIG. 3 is a functional block diagram of software achieved by the CPU 201 reading out the control program stored in the ROM 202 or the HDD 204. The communication apparatus 110 includes a remote client 301. The remote client 301 is an application which establishes a remote operation connection with the MFP 120 via the network 100, and performs remote operation of the MFP 120. Although the present embodiment has been described on the assumption that RFB (Remote Frame Buffer) protocol is used as remote operation connection, HTTP communications may also be used. Note that although to reduce the data amount, the RFB protocol has functions of dividing the screen into a plurality of regions, and transmitting only data of an updated region, and compressing data, the description of such functions is omitted in the present embodiment.

The remote client 301 displays a screen image received from the MFP 120 on the display unit 206 during the establishment of the remote operation connection. In addition, the remote client 301 receives a user operation to the screen image via the input unit 205. Moreover, the remote client 301 transmits the received operation to the MFP 120 via the network 100. In the communication apparatus 110, various other applications can be used, but the description of such applications is omitted.

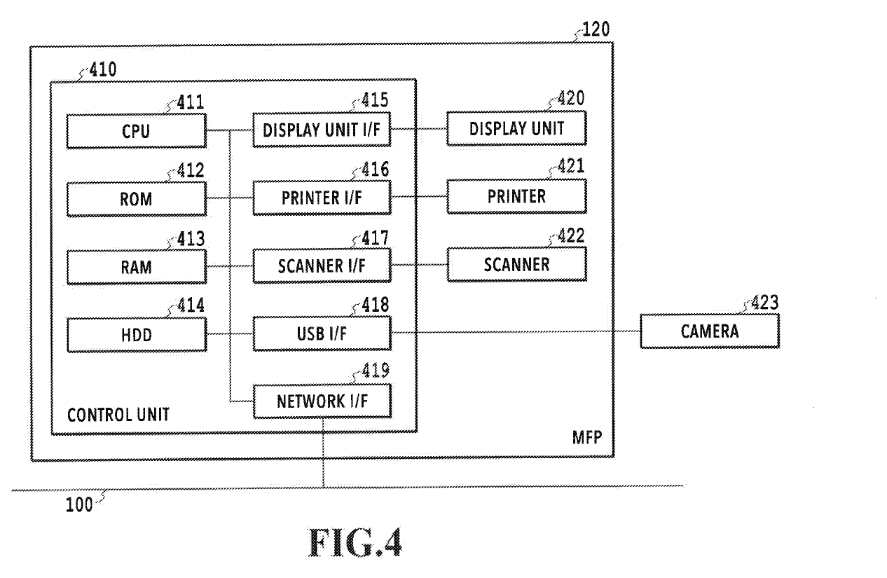

FIG. 4 is a block diagram showing an example of a hardware configuration of the MFP 120. In the present embodiment, the MFP 120 is a multifunction peripheral including a printer 421 and a scanner 422, but may be an apparatus including one of the printer 421 and the scanner 422. In addition, although the present embodiment is described by using the MFP 120 as an example of the information processing apparatus, the information processing apparatus of the present embodiment does not necessarily have to be an image processing apparatus like the MFP 120. The information processing apparatus only has to be an apparatus which is capable of remote operation connection by the remote client 301 and which can be connected with a camera 423.

The MFP 120 includes a control unit 410, a display unit 420, the printer 421, and the scanner 422. The control unit 410 includes a CPU 411, a ROM 412, a RAM 413, an HDD 414, a display unit I/F 415, a printer I/F 416, a scanner I/F 417, a USB I/F 418, and a network I/F 419.

The control unit 410 including the CPU 411 controls the operation of the entire apparatus. The CPU 411 reads out the control program stored in the ROM 412 or the HDD 414, and executes various kinds of control processing. The RAM 413 is used as temporary storage areas such as a main memory and a work area for the CPU 411. The HDD 414 stores various programs and data.

The display unit I/F 415 connects the display unit 420 and the control unit 410. The display unit 420 displays screen information outputted from the control unit 410, and receives operations from the user. Although in FIG. 4, the display unit 420 is an integral unit such as a touch panel capable of detecting touch operations of the user, the display unit 420 and an input unit may be separate configurations. The printer I/F 416 connects the printer 421 and the control unit 410. The scanner I/F 417 connects the scanner 422 and the control unit 410.

The USB I/F 418 connects the camera 423, which is connected from the outside of the MFP 120, and the control unit 410. The camera 423 is a web camera, a network camera, a camera of a smartphone, or the like, and captures an image and a video of the surroundings of the MFP 120 (hereinafter, collectively referred to as a surrounding image). The present embodiment is described on the assumption that a USB device in conformity with the UVC (USB Video Class) specification is used as the camera 423. The UVC is a driver for cameras provided by the OS, and has an interface for using a web camera through a system call. Note that in the example shown in FIG. 4, an example in which the MFP 120 and the camera 423 are separate apparatus configurations is shown, but the camera 423 may be incorporated in the MFP 120. The network I/F 419 connects the control unit 410 to the network 100.

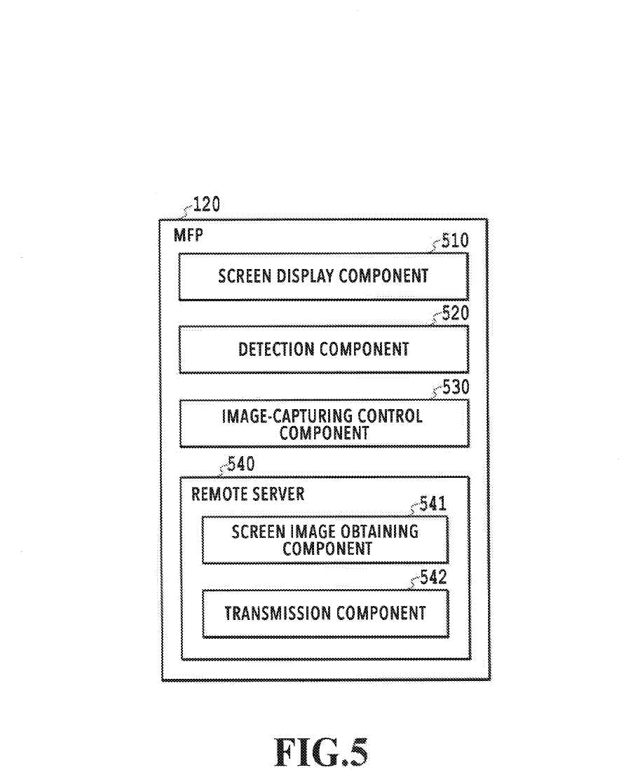

FIG. 5 is a block diagram showing an example of a software configuration of the MFP 120. The CPU 411 reads out programs stored in the HDD 414 of the MFP 120 on the RAM 413 and executes the programs, so that the CPU 411 functions as each component shown in FIG. 5, and executes processing described below. The MFP 120 includes a screen display component 510, a detection component 520, an image-capturing control component 530, and a remote server 540. The remote server 540 includes a screen image obtaining component 541 and a transmission component 542.

The screen display component 510 displays various screens on the display unit 420. In addition, the screen display component 510 displays buttons for calling applications on a menu screen (also referred to as app buttons). The app buttons are buttons for calling various functions such as applications installed in the MFP 120. The detection component 520 detects an image-capturing start event with the camera 423. The image-capturing control component 530 controls the capturing of a surrounding image of the MFP 120 using the camera 423.

The remote server 540 is an application which establishes a remote operation connection with the remote client 301 via the network 100. The screen image obtaining component 541 obtains a screen image which is an image showing the screen of the screen display component 510. The transmission component 542 transmits the screen image to the remote client 301 and receives an operation to the screen image performed in the remote client 301, and notifies the control unit 410 of the received operation.

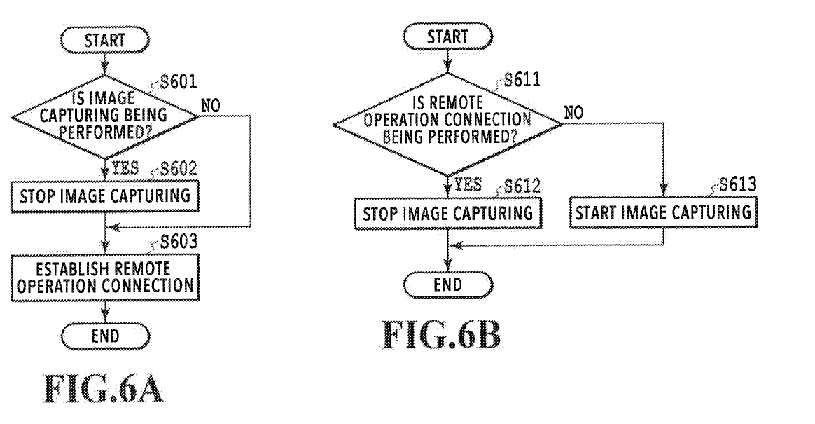

FIGS. 6A and 6B are flowcharts showing an example of the processing executed in the MFP 120 in the present embodiment. The processing shown in FIGS. 6A and 6B is achieved by the CPU 411 of the MFP 120 functioning as each functional component shown in FIG. 5, as described above. That is, the flowcharts of the FIGS. 6A and 6B are achieved by the CPU 411 reading out programs stored in the ROM 412, the HDD 414, or the like on the RAM 413 and executing the programs. Note that part or all of the functions of the steps in FIGS. 6A and 6B may be achieved by hardware such as ASIC or electronic circuits. The sign "S" in the description of each processing means a step in the flowchart diagram (hereinafter, the same applies to the flowchart diagrams in the present Specification).

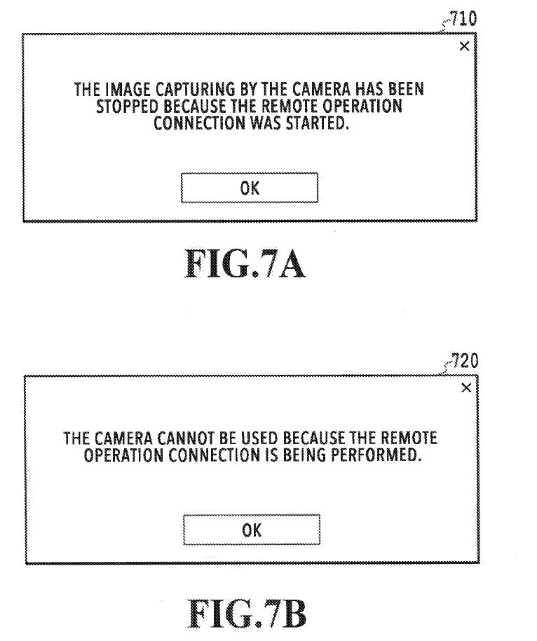

FIG. 6A is a flowchart showing an example of processing at the time of starting the remote operation connection in the MFP 120. The processing of the present flowchart is started based on an event in which the remote server 540 of the MFP 120 has received a connection request which is a request for the remote operation connection from the remote client 301. FIGS. 7A and 7B are examples of camera image-capturing error screens displayed on the display screen of the MFP 120. The processing at the time of starting the remote operation connection in the MFP 120 will be described by using FIGS. 6A and 6B and FIGS. 7A and 7B.

In the case where the remote server 540 receives a connection request from the remote client 301, in S601, the remote server 540 determines whether or not image capturing is being performed. Specifically, the remote server 540 inquires of the image-capturing control component 530 about whether or not image capturing is being performed. The image-capturing control component 530 inquires of the control unit 410 to determine whether or not image capturing by the camera 423 is being performed. If it is determined that image capturing is being performed, the remote server 540 proceeds to S602, and if it is determined that image capturing is not being performed, the remote server 540 proceeds to S603.

In S602, the remote server 540 stops the image capturing by the camera 423. That is, the remote server 540 sends an instruction to stop the image capturing by the camera to the image-capturing control component 530. In the case of stopping the image capturing by the camera, the image-capturing control component 530 displays, on the display unit 420, a message indicating that the image capturing by the camera is stopped. For example, in S602, a message 710 indicating that the image capturing by the camera is stopped, which is shown in FIG. 7A, is displayed on the display screen of the display unit 420. In the message 710, a guidance indicating that the image capturing by the camera has been stopped because the remote operation connection was started is displayed. After S602, the remote server 540 proceeds to S603. As mentioned above, in the case where image capturing is not being performed, the remote server 540 proceeds to S603 without via S602.

In S603, the remote server 540 establishes the remote operation connection with the remote client 301. Specifically, the remote server 540 establishes the remote operation connection in accordance with the connection request, which has triggered the processing of the flowchart of FIG. 6A. Then, the remote server 540 ends the processing of the flowchart shown in FIG. 6A.

FIG. 6B is a flowchart showing an example of processing which is executed in the case where an image-capturing start event of the camera 423 is detected by the detection component 520 of the MFP 120. The processing of the flowchart shown in FIG. 6B is started based on an event in which the image-capturing start event of the camera 423 by a user operation to the screen display component 501 has been detected in the detection component 520 of the MFP 120.

In S611, the image-capturing control component 530 determines whether the MFP 120 is performing the remote operation connection. For example, the image capturing control component 530 determines whether or not the MFP 120 is performing the remote operation connection (VNC connection) by inquiring of the remote server 540. If it is determined that the MFP 120 is performing the remote operation connection, the image-capturing control component 530 proceeds to S612, and if it is determined that the MFP 120 is not performing the remote operation connection, the image-capturing control component 530 proceeds to S613.

In S612, the image-capturing control component 530 stops the image capturing by the camera. Specifically, even in the case where the image-capturing start event of the camera 423 is detected as a trigger of starting the flowchart of FIG. 6B, the image-capturing control component 5330 does not perform the image capturing by the camera. In S612, the image-capturing control component 530 displays, on the display unit 420, a message indicating that the remote operation connection is being performed. For example, in S612, a message 720 indicating that the image capturing by the camera cannot be riot performed, which is shown in FIG. 7B, is displayed on the display screen of the display unit 420. In the message 720, a guidance indicating that the camera cannot be used because the remote operation connection is being performed is displayed. After the processing of S612 has ended, the image-capturing control component 530 ends the processing of the flowchart shown in FIG. 6B.

In S613, the image-capturing control component 530 starts image capturing by the camera 423. Specifically, the image-capturing control component 530 starts image capturing by the camera 423 in response to the detection of the image capturing start event of the camera 423 as a trigger of starting the flowchart of FIG. 6B. Then, the image-capturing control component 530 ends the processing of the flowchart shown in FIG. 6B.

Note that although in the present embodiment, an example in which the image-capturing start event detected by the detection component 520 is a user operation to the display unit 420 has been described, the configuration is not limited to this example. The image-capturing start event may be a detection by a sensor separately attached to the MFP 120. In addition, the detection component 520 may detect a human body operation by using a camera integrated with a human body detection sensor as the image-capturing start event, or may detect an operation instruction by voice input.

In addition, although in the present embodiment, an example in which in the case where a request for the image capturing by the camera and a request for the remote operation connection are performed in parallel, the remote operation connection is prioritized, and the image capturing by the camera is stopped has been described, the configuration is not limited to this. A configuration in which in the case where a request for the image capturing by the camera and a request for the remote operation connection are performed in parallel, the image capturing by the camera is prioritized, and the remote operation connection is stopped may be employed. Alternatively, a configuration in which the user can select which one of a request for the image capturing by the camera and a request for the remote operation connection is prioritized as a setting of the remote server 540 may be employed.

As described above, the present embodiment makes it possible to improve security in a remote operation. That is, in the present embodiment, in the case where there is a request for the image capturing by the camera during the remote operation connection, or in the case where there is a request for the remote operation connection made during the image capturing by the camera, only one of the remote operation connection and the image capturing by the camera is allowed. Then, the control of stopping the other processing is performed. Such a control makes it possible to prevent the remote operation connection and the image capturing by the camera from being simultaneously executed. As a result, it is possible to prevent a captured image from being exposed to a remote client, and to thus reduce security risk.

### Second Embodiment

In the first embodiment, an example in which the image capturing by the camera is stopped so as not to simultaneously perform the processing of both of the remote operation connection and the image capturing by the camera when a request for the remote operation connection is received or when a camera image-capturing start event is detected has been described. Alternatively, an example in which the remote operation connection can be stopped, or the priority of the image capturing by the camera or the remote operation connection can be changed by the user setting has been described. Although these processes can improve the security, since one of the operations is not allowed to be executed in the MFP 120, there is a possibility that the user operability decreases.

In the present embodiment, an example which makes it possible to simultaneously execute the image capturing by the camera and the remote operation connection while protecting the security will be described. In the present embodiment, an example in which an MFP 120 fills (hereinafter, referred to as masks) a captured image to be displayed on a remote client 301 will be described.

The system configuration, the hardware configuration of the communication apparatus, the software configuration of the communication apparatus, and the hardware configuration of the MFP in the present embodiment are the same as those of the example described in the first embodiment, and the descriptions thereof will be omitted.

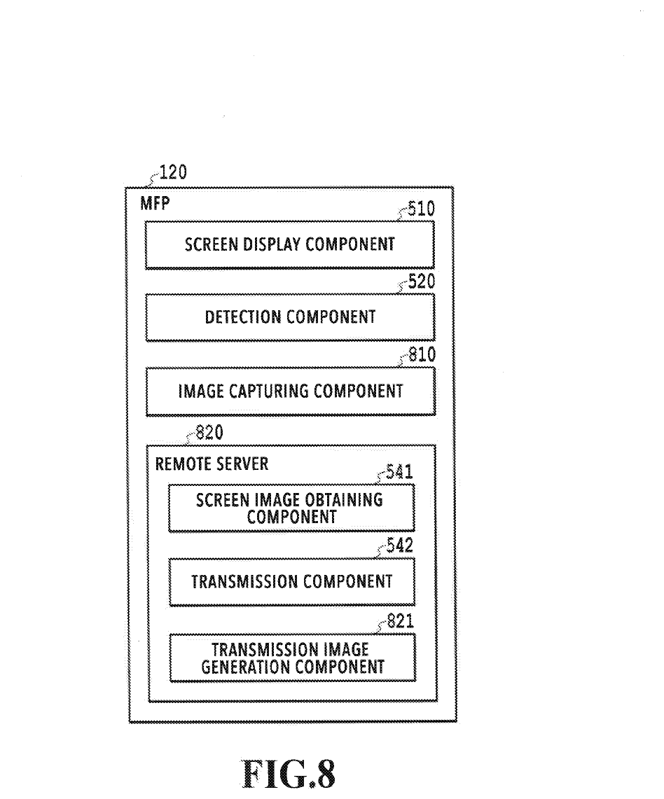

FIG. 8 is a diagram showing an example of a software configuration of the MFP 120 in the present embodiment. The MFP 120 includes a screen display component 510, a detection component 520, an image capturing component 810, and a remote server 820. The remote server 820 includes a screen image obtaining component 541, a transmission component 542, and a transmission image generation component 821.

The screen display component 510 and the detection component 520 are the same as those in the configuration described in the first embodiment. The image capturing component 810 captures a surrounding image of the MFP 120 by using a camera 423. The image-capturing control component 530 of the first embodiment is a processing component which performs control of stopping image capturing in accordance with a situation of the remote operation connection. The image capturing component 810 in the present embodiment is a processing component which does not perform the control of stopping the image capturing in accordance with the situation of the remote operation connection unlike the image-capturing control component 530 of the first embodiment.

The remote server 820 establishes a remote operation connection with the remote client 301 via a network 100. The transmission image generation component 821 in the remote server 820 generates a transmission image to be transmitted to the remote client 301. The screen image obtaining component 541 and the transmission component 542 in the remote server 820 are the same as those of the example described in the first embodiment.

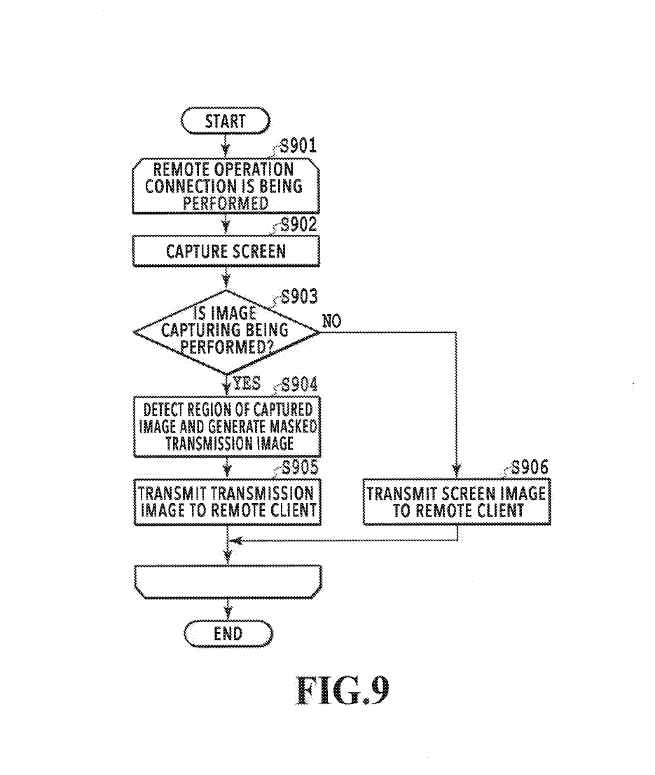

FIG. 9 is a flowchart showing an example of transmission processing of a screen image during the remote operation connection in the MFP 120. The processing shown in FIG. 9 is also achieved by the CPU 411 of the MFP 120 functioning as each functional component shown in FIG. 8, in the same manner as in the example described in FIGS. 6A and 6B. The processing of the flowchart of FIG. 9 is started based on an event in which the remote server 820 has responded to a request for the remote operation connection from the remote client 301 to the remote server 820 and established the remote operation connection.

S901 shows loop processing. The remote server 820 repeats the processing from S902 to S906 during the remote operation connection (during the VNC connection) with the remote client 301. In the case where the remote operation connection with the remote client 301 has ended, the remote server 820 ends the processing of the flowchart shown in FIG. 9.

In S902, the screen image obtaining component 541 captures a screen displayed on the display unit 420. For example, the screen image obtaining component 541 obtains a screen image of the screen display component 510 of the MFP 120. Next, in S903, the remote server 820 determines whether or not the image capturing component 810 is performing image capturing by the camera 423, that is, whether or not image capturing is being performed. For example, the remote server 820 makes the determination by inquiring of the image capturing component 810 about whether image capturing is being performed. If it is determined that image capturing is being performed, the remote server 820 proceeds to S904, and if it is determined that image capturing is not being performed, the remote server 820 proceeds to S906.

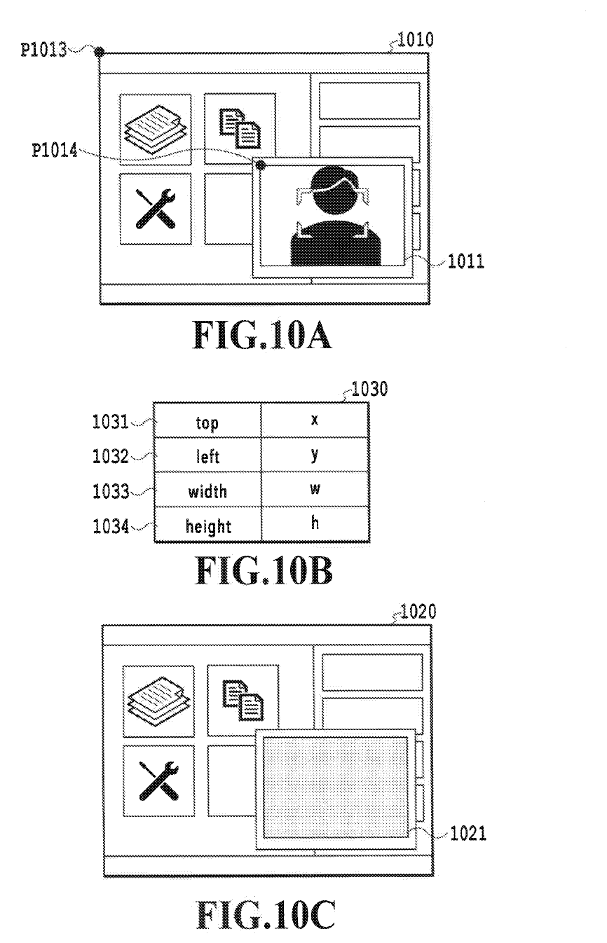

In S904, the remote server 820 causes the transmission image generation component 821 to generate a transmission image. The transmission image is an image which is obtained by masking a region of a captured image in a screen image. The transmission image generation component 821 obtains the screen image from the screen display component 510. In addition, the transmission image generation component 821 obtains, from the RAM 413, region information indicating a region of the captured image in the screen image. Then, by applying mask processing to the region indicated by the region information in the screen image, the transmission image is generated. The detail will be described later by using FIGS. 10A to 10C. Next, in S905, the remote server 820 causes the transmission component 542 to transmit the transmission image generated in S904. Then, the processing is returned to the processing of the loop start of S901. On the other hand, in S906, the remote server 820 causes the transmission component 542 to transmit the screen image displayed by the screen display component 510. Then, the processing is returned to the processing of the loop start of S901.

FIGS. 10A to 10C are diagrams for explaining transmission images. FIG. 10A shows an example of a screen image 1010. FIG. 10B shows an example of coordinate information 1030, which is an example of the region information. FIG. 10C shows an example of a masked transmission image 1020. The coordinate information 1030 is information indicating position coordinates of a captured image 1011 in the screen image 1010 obtained in S904. The coordinate information 1030 contains a distance 1031 in the vertical direction and a distance 1032 in the lateral direction to the upper left (P1014) of the captured image 1011 starting from the upper left (P1013) of the screen image 1010, as well as a lateral width 1033 and a height 1034 of the captured image 1011. By using these pieces of information, the transmission image generation component 821 can specify the region of the captured image 1011 in the screen image 1010. The transmission image generation component 821 applies a mask 1021 on the region of the captured image 1011 in the screen image 1010, specified in this way, to generate a transmission image 1020.

Note that although in the present embodiment, an example in which masking is performed by filling a captured image with a predetermined pattern has been described as an example in which a captured image is not displayed in an image to be transmitted in the remote operation connection, the configuration is not limited to this example. For example, the masking may be performed by overlaying the captured image with another image, or the captured image may be prevented from being displayed by using any method.

As described above, the present embodiment makes it possible to prevent a captured image from being exposed to a remote client by masking a region of the captured image in an image which is transmitted to the remote client, and thus, reduce security risk.

### Third Embodiment

In the second embodiment, an example in which the remote server performs the mask processing of the captured image has been described. In the present embodiment, an example in which the mask processing of the captured image is performed on the remote client side will be described.

The system configuration, the hardware configuration of the communication apparatus, and the hardware configuration of the MFP in the present embodiment can be the same as those in the example described in the first embodiment, and the descriptions thereof will be omitted here.

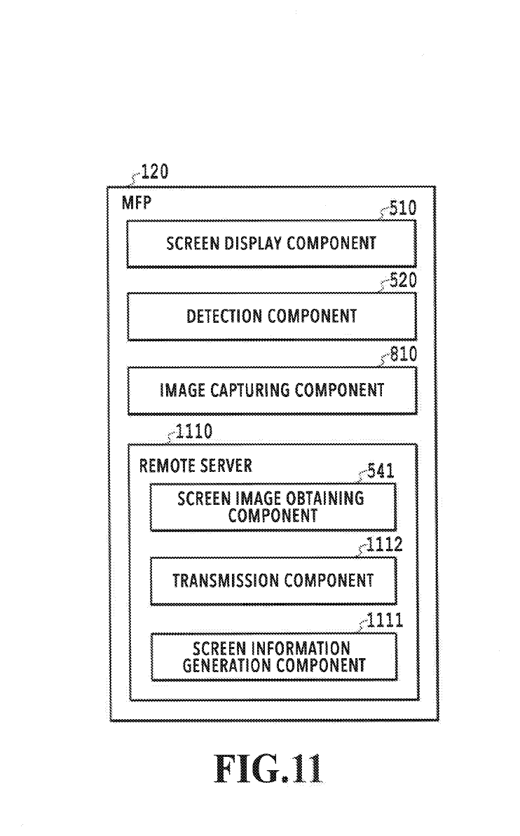

FIG. 11 is a diagram showing an example of a software configuration of an MFP 120 in the present embodiment. The MFP 120 includes a screen display component 510, a detection component 520, an image capturing component 810, and a remote server 1110. The remote server 1110 includes a screen image obtaining component 541, a transmission component 1112, and a screen information generation component 1111.

The screen display component 510 and the detection component 520 are the same as those in the configuration described in the first embodiment. The image capturing component 810 is the same as that in the configuration described in the second embodiment.

The remote server 1110 establishes remote operation connection with a communication apparatus 110 via a network 100. The screen information generation component 1111 in the remote server 1110 generates screen information to be transmitted to a remote client 301. In the present embodiment, data (information) to be transmitted from the remote server 1110 to the remote client 301 is screen information. The screen information may contain only a screen image as described later, or may contain a screen image and also the coordinate information described in the second embodiment. The transmission component 1112 in the remote server 1110 transmits the screen information to the remote client 301. The screen image obtaining component 541 in the remote server 1110 is the same as that in the example described in the first embodiment.

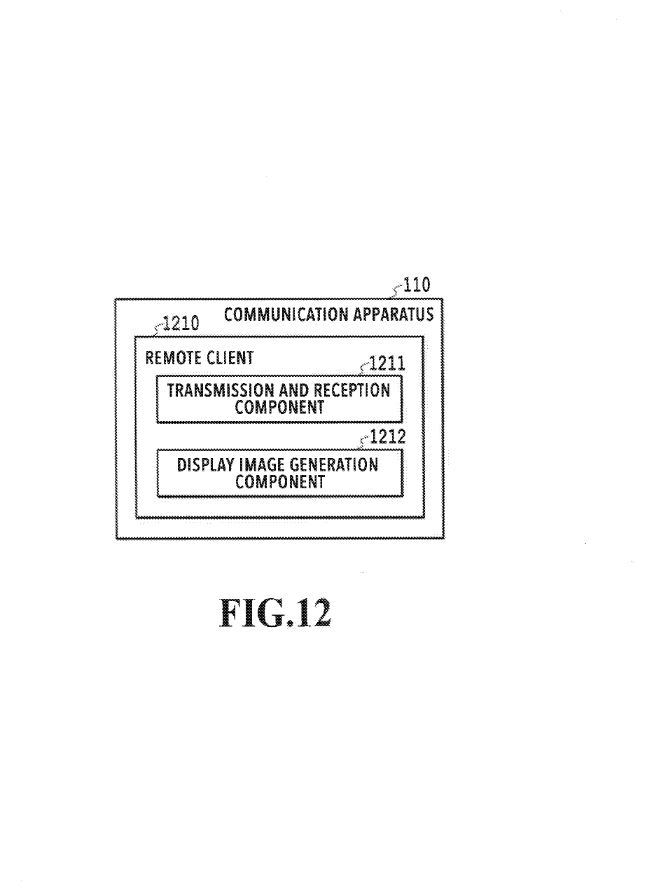

FIG. 12 is a diagram showing an example of a software configuration of the communication apparatus 110 in the present embodiment. The communication apparatus 110 includes a remote client 1210. The remote client 1210 is an application which establishes remote operation connection with the remote server 1110 of the MFP 120 via the network 100. The remote client 1210 includes a transmission and reception component 1211 and a display image generation component 1212.

The display image generation component 1212 in the remote client 1210 generates a display image to be displayed on the display unit 206 of the communication apparatus 110. The transmission and reception component 1211 receives screen information from the remote server 1110 and transmits the screen information to the display image generation component 1212.

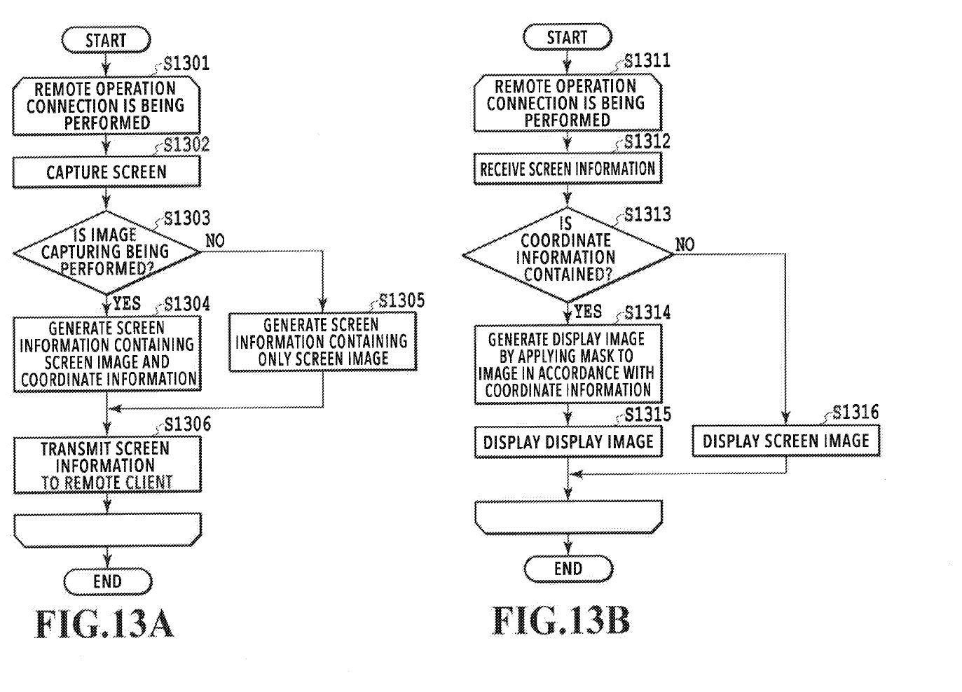

FIGS. 13A and 13B are flowcharts showing an example of transmission and reception processing of screen information during remote operation connection in the present embodiment. FIG. 13A is a flowchart showing an example of transmission processing of screen information which is executed in the MFP 120. FIG. 13B is a flowchart showing an example of reception processing of screen information of the communication apparatus 110. The processing shown in FIG. 13A is also achieved by the CPU 411 of the MFP 120 functioning as each functional component shown in FIG. 11 as mentioned above in the same manner as in the example described in FIGS. 6A and 6B. The processing shown in FIG. 13B is achieved by the CPU 201 of the communication apparatus 110 functioning as each functional component shown in FIG. 12 as mentioned above. That is, the flowchart of FIG. 13B is achieved by the CPU 201 reading out programs stored in the ROM 202, the HDD 204, or the like on the RAM 203 and executing the programs. Note that part or all of the functions of the steps in FIG. 13B may be achieved by hardware such as ASIC or electronic circuits.

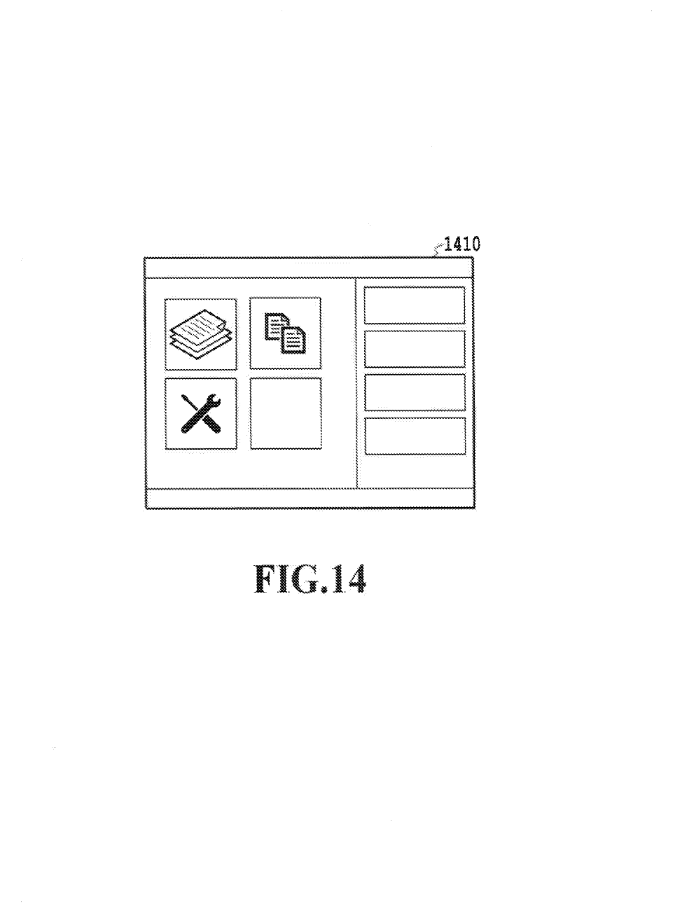

The processing of each of the flowcharts shown in FIGS. 13A and 13B is started based on an event in which the remote operation connection has been established between the remote client 1210 and the remote server 1110. FIG. 14 is a diagram showing screen information in the case where image capturing is not performed by the camera 423.

First, the transmission processing of screen information which is executed in the MFP 120 will be described by using FIG. 13A. S1301 indicates loop processing. The remote server 1110 repeats the processing from S1302 to S1306 during the remote operation connection (during the VNC connection) with the remote client 1210. In the case where the remote operation connection with the remote client 1210 has ended, the remote server 1110 ends the processing of the flowchart shown in FIG. 13A.

In S1302, the screen image obtaining component 541 captures a screen displayed on the display unit 420. For example, the screen image obtaining component 541 obtains a screen image of the screen display component 510 of the MFP 120. Next, in S1303, the remote server 1110 determines whether or not the image capturing component 810 is performing image capturing by the camera 423, that is, whether or not image capturing is being performed. For example, the remote server 1110 makes the determination by inquiring of the image capturing component 810 about whether image capturing is being performed. If it is determined that image capturing is being performed, the remote server 1110 proceeds to S1304, and if it is determined that image capturing is not being performed, the remote server 1110 proceeds to S1305.

In S1304, the remote server 1110 causes the screen information generation component 1111 to generate screen information containing a screen image 1010 and coordinate information 1030 of a captured image 1011 in the screen image 1010, as described in FIGS. 10A to 10C. Then, the remote server 1110 proceeds to S1306.

In S1305, the remote server 1110 causes the screen information generation component 1111 to generate screen information containing a screen image 1410 as shown in FIG. 14. That is, unlike S1304, the remote server 1110 causes the screen information generation component 1111 to generate screen information which does not contain coordinate information but contains screen information. Then, the remote server 1110 proceeds to S1306. Since the screen image 1410 of FIG. 14 is a screen image 1410 in the case where image capturing is not performed by the camera 423, the screen image 1410 of FIG. 14 does not contain a captured image 1011 unlike the example shown in FIG. 10A.

In S1306, the remote server 1110 transmits the screen information generated in S1305 or S1306 to the remote client 1210. Then, the processing returns to the loop start processing of S1301.

Next, the reception processing of screen information which is executed in the communication apparatus 110 will be described by using FIG. 13B. S1311 indicates loop processing. The remote client 1210 repeats the processing from S1312 to S1316 during the remote operation connection (during the VNC connection) with the remote server 1110. In the case where the remote operation connection with the remote server 1110 has ended, the remote client 1210 ends the processing of the flowchart shown in FIG. 13B.

In S1312, the transmission and reception component 1211 of the remote client 1210 receives screen information from the remote server 1110. In S1313, the display image generation component 1212 of the remote client 1210 determines whether coordinate information 1030 is contained in the screen information received in S1312. If it is determined that coordinate information is contained in the screen information, the display image generation component 1212 proceeds to S1314, and if it is determined that coordinate information is not contained in the screen information, the display image generation component 1212 proceeds to S1316.

In S1314, the display image generation component 1212 generates a display image by applying a mask 1021 to a region indicated by the coordinate information 1030 in the screen image 1010 as described in FIGS. 10A to 10C. An example of the mask processing is the same as the example described in the third embodiment. Then, the display image generation component 1212 proceeds to S1315.

In S1315, the display image generation component 1212 displays the display image generated in S1314 on the display unit 206.Then, the processing returns to the loop start processing of S1311.

In S1316, the display image generation component 1212 displays the screen image received in S1312 on the display unit 206. Then, the processing returns to the loop start processing of S1311.

As described above, the present embodiment makes it possible to prevent a captured image from being exposed to a remote client by performing the processing of masking the captured image in the remote client 1210, and thus reduce security risk.

### Fourth Embodiment

In the first embodiment, an example in which the image capturing by the camera is stopped so as not to simultaneously perform the processing of the remote operation connection and the image capturing by the camera when a request for the remote operation connection is received and when a camera image-capturing start event is detected has been described. Although this can improve the security, since the stopping of the image capturing by the camera prevents the operation in the MFP 120 from being performed, there is a possibility that the user operability decreases. For example, there can be a case where the use of a captured image of the camera 423 is not only facial authentication for login to the MFP 120 but also two-dimensional code reading for a print job input. In this case, despite the fact that it is no problem to expose a two-dimensional code to the remote client 301, the image capturing by the camera is stopped.

In view of this, in the present embodiment, an example in which the control of the image capturing by the camera and the remote operation connection is performed after an authentication setting and a login state of the MFP 120 are checked will be described. The system configuration, the hardware configuration of the communication apparatus, the software configuration of the communication apparatus, the hardware configuration of the MFP, and the software configuration of the MFP in the present embodiment can be the same as those of the example described in the first embodiment, and the descriptions thereof will be omitted.

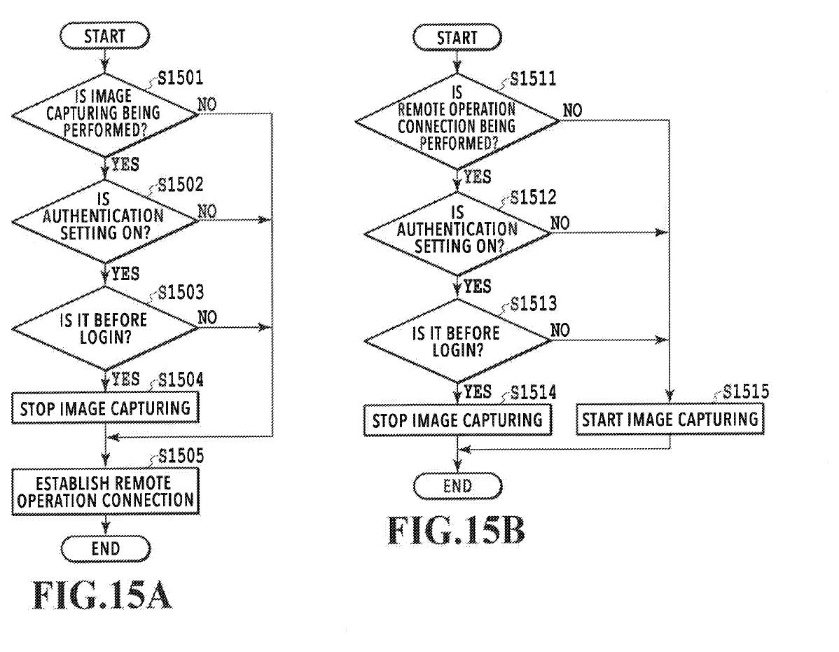

FIGS. 15A and 15B are flowcharts showing an example of processing executed in an MFP 120 in the present embodiment. The processing shown in FIGS. 15A and 15B is achieved by a CPU 411 of the MFP 120 functioning as each functional component shown in FIG. 5, as described above.

FIG. 15A is a flowchart showing processing at the time of starting a remote operation connection in the MFP 120. The processing of the flowchart shown in FIG. 15A is started based on an event in which the remote server 540 has received a connection request from the remote client 301. FIG. 15A is different from FIG. 6A in that S1502 and S1503 are added. S1501, S1504, and S1505 other than that are the same as S601, S602, and S603 in FIG. 6A, and descriptions thereof will be omitted.

In S1502, the remote server 540 requests the control unit 410 to obtain authentication setting of the MFP 120, which is stored in the HDD 414, and determines whether the authentication setting is ON. If it is determined that the authentication setting is ON, the remote server 540 proceeds to S1503, and if it is determined that the authentication setting is not ON, the remote server 540 proceeds to S1505.

S1503, the remote server 540 inquires of the control unit 410 about whether the user login to the MFP 120 is being performed to determine whether it is before the login. If it is determined that it is before the login, the remote server 540 proceeds to S1504, and if it is determined that it is not before the login, the remote server 540 proceeds to S1505.

That is, in the processing shown in FIG. 15A, if the request for the remote operation connection is received in the case where the authentication setting is ON and it is before the login, the processing of stopping image capturing and establishing the remote operation connection is performed. This is because there is a high possibility that the use of the captured image of the camera 423 is the use of facial authentication for logging in the MFP 120, and the processing of stopping image capturing is thus performed in order to improve the security. On the other hand, in the case where the authentication setting is OFF, or in the case where the authentication setting is ON and the login has already been made, there is a high possibility that the use of the captured image of the camera 423 is not the use of facial authentication for logging in the MFP 120. In this case, since the concern about the security is low, the processing of establishing the remote operation connection without stopping image capturing is performed.

Next, processing when an image-capturing start event of the camera 423 is detected by the detection component 520 of the MFP 120 will be described by using FIG. 15B. The processing of the flowchart shown in FIG. 15B is started based on an event in which the image-capturing start event of the camera 423 by the user operation to the screen display component 501 has been detected by the detection component 520 of the MFP 120. FIG. 15B is different from FIG. 6B in that S1512 and S1513 are added. S1511, S1514, and S1515 other than that are the same as S611, S612, and S613 in FIG. 6B, and descriptions thereof will be omitted.

In S1512, the image-capturing control component 530 requests the control unit 410 to obtain authentication setting of the MFP 120, which is stored in the HDD 414, and determines whether the authentication setting is ON. If it is determined that the authentication setting is ON, the image-capturing control component 530 proceeds to S1513, and if it is determined that the authentication setting is not ON, the image-capturing control component 530 proceeds to S1515. In S1513, the image-capturing control component 530 inquires of the control unit 410 about whether the user login to the MFP 120 is being performed to determine whether it is before the login. If it is determined that it is before the login, the image-capturing control component 530 proceeds to S1514, and if it is determined that it is not before the login, the image capturing control component 530 proceeds to S1515.

That is, in the processing shown in FIG. 15B, if the image-capturing start event is detected in the case where it is during the remote operation connection, the authentication setting is ON, and it is before the login, the processing of stopping image capturing is performed. This is because there is a high possibility that the use of the captured image of the camera 423 is the use of facial authentication for logging in the MFP 120, and the processing of stopping image capturing is thus performed in order to improve the security. On the other hand, in the case where the authentication setting is OFF during the remote operation connection, or in the case where the authentication setting is ON and the login has already been made, there is a high possibility that the use of the captured image of the camera 423 is not the use of facial authentication for logging in the MFP 120. In this case, since the concern about the security is low, the processing of starting image capturing is performed in accordance with the image-capturing start event.

Note that in the present embodiment, the login state when the authentication setting of the MFP 120 is ON has been described as an example of image capturing use in the case of performing control to prevent the remote operation connection and the image capturing by the camera from being simultaneously performed. Here, for example, it is also possible to employ processing of display control to generate a state in which the face of a person is not recognized in a camera captured image and to prevent the face from being displayed, other than the control of not performing image capturing by the camera.

In addition, at the time of remote operation connection from service staff, like in the case where image capturing cannot be performed by the camera 423, or in the case where the user login using a captured image cannot be performed, or the like, it is efficient to be able to perform the work while checking a captured image of the camera 423. For this reason, a configuration in which at the time of connection request by a specific remote client, a specific parameter is applied, and the simultaneous execution of the remote operation connection and the image capturing by the camera is permitted depending on whether or not the specific parameter in request parameters is present may be employed.

In addition, a configuration in which under a policy that a captured image may be exposed within the same network such as a company LAN, the simultaneous execution of the remote operation connection and the image capturing by the camera is permitted in the case of belonging to the same network may be employed. In this case, for example, the following processing may be performed in place of S1502 to S1503 and S1512 to S1513. Specifically, processing of determining whether results of performing a logical AND operation on the IP address of a remote client and the IP address of an image processing apparatus in a subnet mask of the image processing apparatus are the same as each other may be employed. Then, a configuration in which if they are in the same network, processing of S1505 or S1515 is executed, and if it is determined that they are not in the same network, processing of S1504 or S1514 is executed may be employed. In this way, the simultaneous execution of the remote operation connection and the image capturing by the camera can be permitted if they are in the same network such as a company LAN.

As described above, the present embodiment makes it possible to permit the simultaneous execution of the remote operation connection and the image capturing by the camera in the case where a predetermined condition where the security risk is low is satisfied. This makes it possible to improve the usability. On the other hand, under a condition where the security risk is high, the security risk can be reduced by performing the control to inhibit the simultaneous execution of the remote operation connection and the image capturing by the camera as described in the first embodiment.

### Other Embodiments

In the fourth embodiment, an example in which the simultaneous execution of the remote operation connection and the image capturing by the camera is not inhibited as described in the first embodiment and the fourth embodiment but is permitted in the case where the predetermined condition where the security risk is low is satisfied has also been described. This processing in the case where the predetermined condition is satisfied can be applied to the examples described in the second embodiment and the third embodiment. Specifically, a configuration in which in the case where the aforementioned predetermined condition is satisfied, the processing of masking is not performed may be employed. For example, a configuration in which after the determination of YES in S903, it is determined whether the predetermined condition is satisfied, and if the predetermined condition is satisfied, the processing proceeds to S906, and if the predetermined condition is not satisfied, the processing of S904 is performed may be employed. Similarly, a configuration in which after the determination of YES in S1303, it is determined whether the predetermined condition is satisfied, and if the predetermined condition is satisfied, the processing proceeds to S1305, and if the predetermined condition is not satisfied, the processing of S1304 is performed may be employed.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present disclosure makes it possible to improve security in a remote operation.

This application claims the benefit of Japanese Patent Application No. 2024-165529, filed September 24, 2024, which is hereby incorporated by reference herein in its entirety.

What is claimed is:

1. An information processing apparatus comprising:
one or more memories storing instructions; and
one or more processors which function as:
an image-capturing control unit configured to control capturing of an image of surroundings of the information processing apparatus;
a detection unit configured to detect an event of starting the capturing of an image;
a display control unit configured to display, on a display screen, a captured image which is an image captured based on the control by the image-capturing control unit;
a connection unit configured to perform remote operation connection with a communication apparatus, to display, in the communication apparatus, an image displayed on the display screen, and to enable an operation from the communication apparatus to the information processing apparatus; and
a control unit configured to perform control to stop the capturing of an image by the image-capturing control unit, or to stop the remote operation connection, in a case where a request for the remote operation connection is received in the connection unit, or in a case where the event is detected by the detection unit during the remote operation connection.

2. The information processing apparatus according to claim 1, wherein the control unit performs control to stop the capturing of an image by the image-capturing control unit in the case where the request for the remote operation connection is received in the connection unit, and performs control to stop the capturing of an image by the image capturing control unit in the case where the event is detected by the detection unit during the remote operation connection.

3. The information processing apparatus according to claim 1, wherein in a case where the control to stop the capturing of an image by the image-capturing control unit has been performed, the display control unit displays a message indicating the stop on the display screen.

4. The information processing apparatus according to claim 1, wherein in a state where a predetermined condition is satisfied, the control unit performs control not to stop the capturing of an image by the image-capturing control unit and not to stop the remote operation connection, even in the case where the request for the remote operation connection is received in the connection unit, or in the case where the event is detected by the detection unit during the remote operation connection.

5. The information processing apparatus according to claim 4, wherein the predetermined condition includes that authentication setting of the information processing apparatus is not ON.

6. The information processing apparatus according to claim 5, wherein the predetermined condition includes that login has already been made even in a case where the authentication setting is ON.

7. The information processing apparatus according to claim 4, wherein the predetermined condition includes that a specific parameter has been applied in a case where the request for the remote operation connection is made from the communication apparatus.

8. The information processing apparatus according to claim 4, wherein the predetermined condition includes that the information processing apparatus and the communication apparatus belong to the same network.

9. A method for controlling an information processing apparatus, comprising:
controlling capturing of an image of surroundings of the information processing apparatus;
detecting an event of starting the capturing of an image;
displaying, on a display screen, a captured image which is an image captured based on the control;
performing remote operation connection with a communication apparatus, to display, in the communication apparatus, an image displayed on the display screen and to enable an operation from the communication apparatus to the information processing apparatus; and
performing control to stop the capturing of an image, or to stop the remote operation connection, in a case where a request for the remote operation connection is received, or in a case where the event is detected during the remote operation connection.

10. A non-transitory computer readable storage medium storing a program which causes a computer to execute:
a method for controlling an information processing apparatus, comprising:
controlling capturing of an image of surroundings of the information processing apparatus;
detecting an event of starting the capturing of an image;
displaying, on a display screen, a captured image which is an image captured based on the control;
performing remote operation connection with a communication apparatus, to display, in the communication apparatus, an image displayed on the display screen and to enable an operation from the communication apparatus to the information processing apparatus; and
performing control to stop the capturing of an image, or to stop the remote operation connection, in a case where a request for the remote operation connection is received, or in a case where the event is detected during the remote operation connection.
